(19) United States
(12) Patent Application Publication
(10) Pub. No.: US 2008/0173089 A1
(43) Pub. Date: Jul. 24, 2008

(54) Transducing system with integrated environmental sensors

(75) Inventors: John S. Wright, Minneapolis, MN (US); Craig T. Gerber, Longmont, CO (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Seagate Technology LLC, Scotts Valley, CA (US)

(21) Appl. No.: 11/655,550

(22) Filed: Jan. 19, 2007

(51) Int. Cl. G01N 27/22; G01D 11/24; G01L 9/12; G01K 7/16; G01N 27/04

(52) U.S. Cl. 73/335.04; 73/431; 374/142; 73/724; 374/E07.018

(57) ABSTRACT

A transducing system includes a support structure configured to support a transducer and includes at least one environmental sensor carried by the support structure. The environmental sensor may be a humidity sensor, a temperature sensor, an altitude sensor, or a combination of these.

### BACKGROUND OF THE INVENTION

The present invention relates to the provision of environmental sensors, such as humidity, temperature and altitude sensors, in an electronic or mechanical device.

As electronic and mechanical devices continue to be developed and used in more and more mobile applications, the variety of environmental conditions to which the devices may be exposed continues to increase. In some of these devices, it is important to monitor one or more environmental conditions to ensure that the device is able to operate properly in the environment in which it is present. For example, extreme values of humidity, temperature and altitude have the potential to affect the operating performance of an electronic device.

While it is desirable to monitor environmental conditions, the provision of environmental sensors typically adds cost to the manufacture of a device, and can present design challenges to ensure that the placement of the environmental sensors achieves effective condition sensing without adversely affecting the operation of the device. A low-cost environmental sensor configuration that is designed to integrate with the device in a way that does not inhibit device performance would be a useful improvement to the state of the art.

### BRIEF SUMMARY OF THE INVENTION

The present invention is a transducing system having a support structure configured to support a transducer and having at least one environmental sensor carried by the support structure. The environmental sensor may be a humidity sensor, a temperature sensor, an altitude sensor, or a combination of these.

### BRIEF DESCRIPTION OF THE DRAWINGS

FIG. 1 is a diagram illustrating a portion of a support structure assembly, including a capacitive humidity sensor.

FIG. 2 is a diagram illustrating a portion of a support structure assembly, including a resistive humidity sensor.

FIG. 3 is a diagram illustrating a portion of a support structure assembly, including a resistive temperature sensor.

FIG. 4A is a diagram illustrating a top view of a portion of a support structure assembly, including a capacitive atmospheric pressure (altitude) sensor.

FIG. 4B is a diagram illustrating an exploded view of a portion of the capacitive atmospheric pressure (altitude) sensor shown in FIG. 4A.

### DETAILED DESCRIPTION

In accordance with the present invention, at least one environmental sensor, such as a humidity sensor, a temperature sensor, and/or an altitude sensor, is integrated into the design of a device. Examples of humidity sensors, temperature sensors, and altitude sensors are provided, but should not be construed to limit the configurations in which the present invention are applicable.

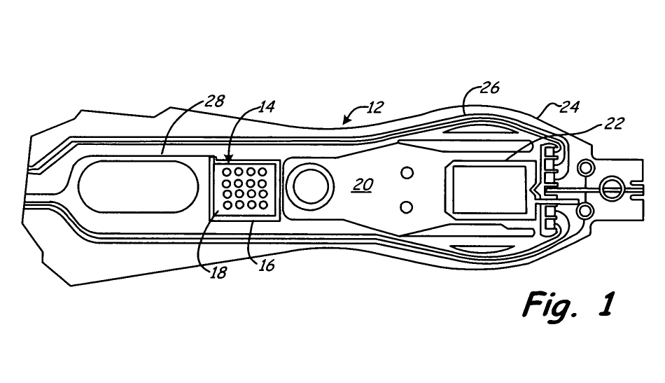

FIG. 1 is a diagram illustrating support structure assembly 12 of device 10, including capacitive humidity sensor 14. Humidity sensor 14 in this embodiment is formed by dielectric material 16 sandwiched between patterned top electrode 18 and a bottom electrode formed by stainless steel suspension 20 of device 10. The other components of device 10 are shown in the exemplary configuration of FIG. 1, and include slider 22 supported by suspension 20 and carrying one or more transducers, and flex circuit 24 having one or more leads 26 for electrical connection to the transducer(s) carried by slider 22. An additional lead 28 is provided on flex circuit 24 to electrically contact top electrode 18 of humidity sensor 14 (the bottom electrode formed by stainless steel suspension 20 is held at ground, as is conventional). In the embodiment shown in FIG. 1, humidity sensor 14 is located at a portion of suspension 20 that does not provide gimbaling spring, so that the structure of humidity sensor 14 does not have any effect on the mechanical properties of suspension 20.

In one embodiment, humidity sensor 14 includes dielectric material 16 composed of polyimide or a similar material. The polyimide absorbs more water as environmental humidity increases, thereby changing the dielectric constant of the material. Polyimide has a dielectric constant of about 5, while water has a dielectric constant of about 80. Therefore, as greater amounts of water are absorbed by the polyimide, the dielectric constant of the material between patterned top electrode 18 and the bottom electrode (formed by stainless steel suspension 20) increases, causing the capacitance to increase as well. In some embodiments, the polyimide is made thinner, is roughened (such as by oxygen plasma treatment), or is otherwise made porous in order to increase the sensitivity of humidity sensor 14 to changes in humidity.

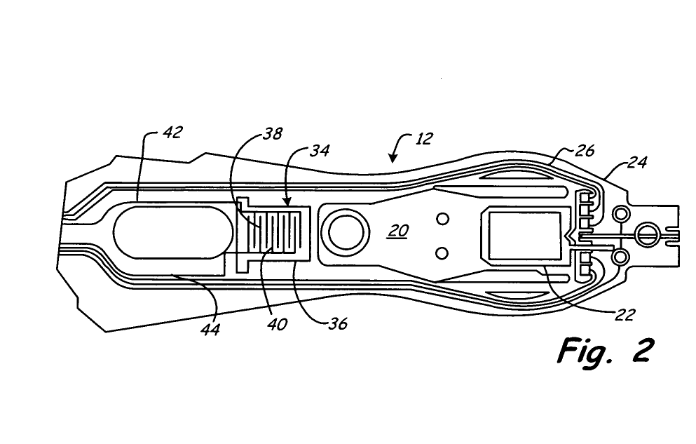

FIG. 2 is a diagram illustrating support structure assembly 12 of device 10, including resistive humidity sensor 34. Humidity sensor 34 in this embodiment is formed by dielectric layer 36 having interdigitated electrodes 38 and 40 patterned thereon. The other components of device 10 are configured as normal (and as described above with respect to FIG. 1). Two additional leads 42 and 44 are provided on flex circuit 26 to electrically contact electrodes 38 and 40. In the embodiment shown in FIG. 2, humidity sensor 34 is located at a portion of suspension 20 that does not provide gimbaling spring, so that the structure of humidity sensor 34 does not have any effect on the mechanical properties of suspension 20.

In one embodiment, humidity sensor 34 includes dielectric material 36 composed of polyimide or a similar material. The polyimide absorbs more water as environmental humidity increases, thereby changing the surface resistivity of the material. As greater amounts of water are absorbed by the polyimide, the surface resistivity decreases as well, and is measured between interdigitated electrodes 38 and 40. In some embodiments, the surface of the polyimide is roughened (such as by oxygen plasma treatment) to increase the sensitivity of humidity sensor 14 to changes in humidity.

Interdigitated electrodes 38 and 40 also produce a fringing field in dielectric material 36 (e.g., polyimide), so that capacitance increases as humidity increases. Thus, humidity sensor 34 can be used as either a resistive sensor or a capacitive sensor.

Although humidity sensors 14 and 34 have been described relatively simplistically as sensing humidity, those skilled in the art will recognize that in particular embodiments, humidity sensors 14 and 34 are utilized to measure specific humidity, in units of water per units of air.

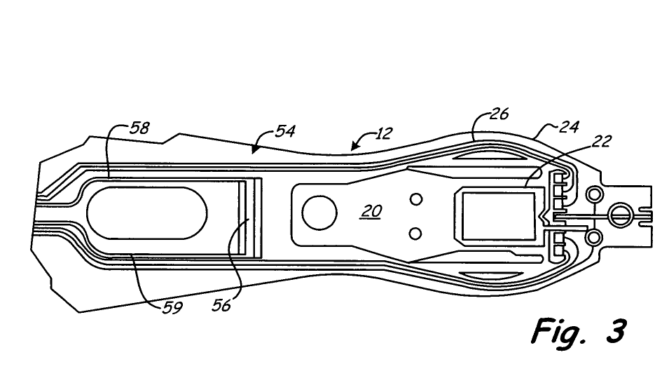

FIG. 3 is a diagram illustrating support structure assembly 12 of device 10, including resistive temperature sensor 54. Temperature sensor 54 in this embodiment is formed by conductive trace 56 formed of a material having a resistance that varies with temperature, such as copper, nickel, gold, or others. The other components of device 10 are configured as normal (and as described above with respect to FIG. 1). The provision of conductive trace 56 adds an additional lead 58, and one end of the trace is connected to ground, either by a ground trace (shown as lead 59) or a via (not shown) to a grounded component such as suspension 20. In the embodiment shown in FIG. 3, temperature sensor 54 is located at a portion of suspension 20 that does not provide gimbaling spring, so that the structure of temperature sensor 54 does not have any effect on the mechanical properties of suspension 20.

In operation, a known current is delivered through conductive trace 56, allowing a measurement of voltage across the trace to indicate the resistance associated with the trace. Because conductive trace 56 is formed of a material having a resistance that varies with temperature, the determined resistance can be correlated to provide a measurement of temperature.

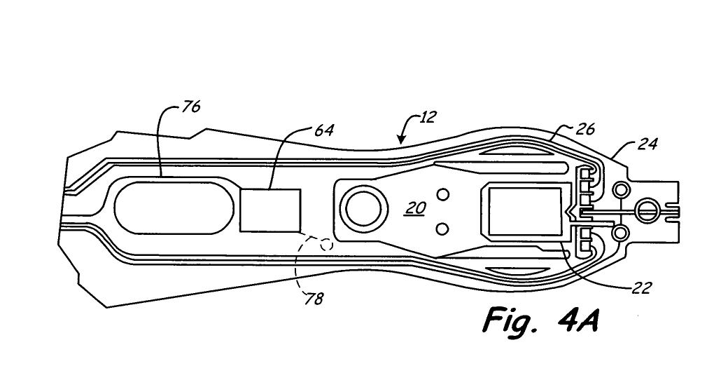

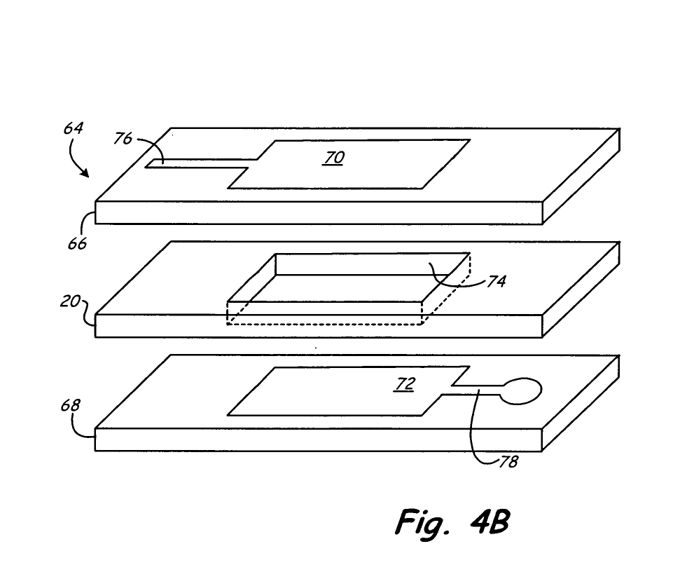

FIGS. 4A and 4B are diagrams (FIG. 4A is a top view, and FIG. 4B is an exploded view) illustrating support structure assembly 12 of device 10, including capacitive atmospheric pressure (altitude) sensor 64. Altitude sensor 64 in this embodiment is formed by dielectric layers 66 and 68 attached on opposite sides of suspension 20, with top electrode 70 formed on the top surface of top dielectric layer 66, bottom electrode 72 formed on the top surface of bottom dielectric layer 68, and aperture 74 being formed through suspension 20 in the area between top electrode 70 and bottom electrode 74. The other components of device 10 are configured as normal (and as described above with respect to FIG. 1). Conductive trace 76 connects to top electrode 70 to make an electrical connection to an electronic circuit, and conductive trace 78 connects to suspension 20 to hold bottom electrode 74 at ground.

In one embodiment, dielectric layers 66 and 68 are composed of polyimide or a similar material that undergoes mechanical deflection with changes in altitude (i.e., atmospheric pressure). As dielectric layers 66 and 68 deflect, the size of the air gap through aperture 74 changes, causing the capacitance between top electrode 70 and bottom electrode 74 to change as well. Thus, the capacitance between top electrode 70 and bottom electrode 74 can be sensed to determine altitude.

The environmental sensors provided in the various embodiments shown in FIGS. 1-3, 4A and 4B and discussed above are integral to the structure of the electromechanical device on which they are provided. Thus, the cost of providing these sensors, and the design effort required to accommodate these sensors, are kept small. The environmental sensors are each formed by at least one conductive layer and at least one dielectric layer on the transducer support structure, configured such that at least one characteristic of the conductive layer and/or the dielectric layer varies as at least one environmental condition varies. The humidity sensor shown in FIG. 1 has a moisture-absorbing dielectric layer between a patterned electrode and the support structure, so that the capacitance between the patterned electrode and the support structure varies as the moisture absorbed by the dielectric layer varies. The humidity sensor shown in FIG. 2 has first and second interdigitated electrodes on a moisture-absorbing dielectric layer on the support structure, so that the surface resistivity measured between the interdigitated electrodes varies as the moisture absorbed by the dielectric layer varies. The temperature sensor shown in FIG. 3 has a conductive layer on a dielectric layer on the support structure, so that the resistivity of the conductive layer varies as temperature varies. The altitude sensor shown in FIGS. 4A and 4B has first and second dielectric layers on opposite sides of the support structure, with a first electrode on the first dielectric layer, a second electrode on the second dielectric layer, and an aperture through the support structure between the first and second electrodes, so that the capacitance between the first and second electrodes varies as the first and second dielectric layers deflect due to changes in atmospheric pressure. Other possible configurations of conductive and dielectric layers will be apparent to those skilled in the art. Furthermore, the illustrated locations of the sensors on a support structure are shown only as examples of possible locations, and those skilled in the art will understand that many possible integral locations for the sensors disclosed are possible, such as on the printed circuit card assembly that interconnects the transducer(s) to a preamplifier, or at other locations.

Although the present invention has been described with reference to preferred embodiments, workers skilled in the art will recognize that changes may be made in form and detail without departing from the spirit and scope of the invention.

1. A transducing system comprising:
a support structure configured to support a transducer; and
at least one environmental sensor selected from the group consisting of a humidity sensor, a temperature sensor and an altitude sensor, the at least one sensor being carried by the support structure.

2. The transducing system of claim 1, wherein the at least one sensor comprises a humidity sensor configured with a layer of moisture-absorbing dielectric material between an electrode and the support structure.

3. The transducing system of claim 2, wherein the moisture-absorbing dielectric material comprises a layer of polyimide on the support structure, and the electrode is a conductive layer formed on the polyimide.

4. The transducing system of claim 1, wherein the at least one sensor comprises a humidity sensor configured with interdigitated electrodes on a moisture-absorbing dielectric material having a surface resistivity and/or capacitance that varies with absorbed moisture.

5. The transducing system of claim 4, wherein the moisture-absorbing dielectric material comprises a layer of polyimide on the support structure.

6. The transducing system of claim 1, wherein the at least one sensor comprises a temperature sensor configured with a conductive trace having a resistance that varies with temperature.

7. The transducing system of claim 6, wherein the conductive trace is composed of a material selected from the group consisting of copper, nickel, gold, and combinations thereof.

8. The transducing system of claim 1, wherein the at least one sensor comprises an altitude sensor configured with at least one dielectric membrane having a deflection that varies with atmospheric pressure.

9. The transducing system of claim 8, wherein the altitude sensor comprises:
a first dielectric layer on a first surface of the support structure, the first dielectric layer having a first electrode formed thereon;
a second dielectric layer on a second surface of the support structure opposite the first surface, the second dielectric layer having a second electrode formed thereon and being located opposite the first electrode through an aperture in the support structure to form an air gap between the first and second electrodes.

10. The transducing system of claim 9, wherein the first dielectric layer and the second dielectric layer are composed of polyimide.

11. The transducing system of claim 9, wherein one of the first electrode and the second electrode is electrically connected to the support structure.

12. The transducing system of claim 1, wherein the support structure comprises a suspension for supporting a slider that carries the transducer.

13. The transducing system of claim 12, wherein the at least one environmental sensor is located on a region of the suspension that does not provide gimbaling spring.

14. A transducing system comprising:
a support structure configured to support a transducer; and
at least one environmental sensor carried by the support structure, the sensor being formed by at least one conductive layer and at least one dielectric layer on the support structure configured such that at least one characteristic of the conductive layer and/or the dielectric layer varies as at least one environmental condition varies.

15. The transducing system of claim 14, wherein the at least one environmental sensor comprises a humidity sensor having a layer of moisture-absorbing dielectric material between a patterned first electrode connected to a conductive trace and the support structure serving as a second electrode, the humidity sensor having a capacitance between the first and second electrodes that varies as moisture absorbed by the dielectric material varies.

16. The transducing system of claim 14, wherein the at least one environmental sensor comprises a humidity sensor having first and second interdigitated electrodes on a layer of moisture-absorbing dielectric material on the support structure, the humidity sensor having a resistance and/or capacitance between the first and second interdigitated electrodes that varies as moisture absorbed by the dielectric material varies.

17. The transducing system of claim 14, wherein the at least one environmental sensor comprises a temperature sensor configured with the conductive layer on the dielectric layer on the support structure, the conductive layer having a resistance that varies as temperature varies.

18. The transducing system of claim 14, wherein the at least one environmental sensor comprises an altitude sensor comprising:
a first layer of dielectric material on a first side of the support structure;
a second layer of dielectric material on a second side of the support structure opposite the first side;
a first electrode on the first layer of dielectric material, the first electrode being connected to a conductive trace;
a second electrode on the second layer of dielectric material, the second electrode being coupled to ground; and
an aperture in the support structure between the first electrode and the second electrode;
wherein a capacitance between the top electrode and the bottom electrode varies as changes in atmospheric pressure cause deflection of the first layer of dielectric material and the second layer of dielectric material.
